(19) United States
(12) Patent Application Publication
(10) Pub. No.: US 2010/0199297 A1
(43) Pub. Date: Aug. 5, 2010

(54) Method of conducting a reality show

(76) Inventor: Eftim Cesmedziev, San Pedro, CA (US)

Correspondence Address: Eftim Cesmedziev, 326 S. Miraleste Drive 198, San Pedro, CA, 90732, US

(21) Appl. No.: 12/322,663

(22) Filed: Feb. 2, 2009

(51) Int. Cl. H04N 7/173; G06Q 99/00; G06Q 30/00

(52) U.S. Cl. 725/24; 705/14.4; 705/1.1

(57) ABSTRACT

A method of conducting a reality show is created, that allow unlimited numbers of participants in the show and eliminates the limits of broadcasting episodes, using the commercials breaks as a part of the reality show solution.

### RELATED APPLICATION

Not applicable

### STATEMENT REGARDING STATE SPONSORED RESEARCH OF DEVELOPMENT

Not applicable

### NOTICE OF MATERIAL SUBJECT TO COPYRIGHT PROTECTION

A portion of the material in this patent document is subject to copyright protection under the copyright laws of the United States of America and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R., section 1.14.

### FIELD OF INVENTION

The present invention generally relates to broadcasting production, and more specifically, to systems and methods for conducting a reality show.

### BACKGROUND OF THE INVENTION

At any given time, there is a more number of viewers who watch the broadcasting program then people who are participating in the broadcasted program. For example, if the broadcasted program is a reality show, only selected numbers of people are participating in the show competing for the price. For the other side, there are millions of viewers who are watching the same reality show without chance to participating in the show. Those people who are participating in the reality show are pre-selected before the program is created and broadcasted. The pre-selecting the people are necessary because the broadcasting program is limited by the expensive broadcasting airtime and the contest of the reality show may be alternated to fit in the expensive broadcasting airtime. That practice is limiting the quality of the broadcasting program. The money for the expensive broadcasting airtime comes from revenues that are usually collected from advertisements or commercials presentation, as a part of the reality show. Manufacturers and service providers spend advertising money to attract targeted viewers to promote their goods and services and they seek to have a profit from the sponsorship of the reality show. But, very often viewers of the broadcasted program do not watch the advertising between the broadcasted parts of the program, so manufacturers and service providers do not get back expected revenues from their invested money. Therefore, the effectiveness of the advertisements is low.

Currently, there is a lack of a reliable revenue structure and business model in television broadcasting program that address these issues and find solution to solve these problems. Therefore, an object of the present invention is to provide a new business model for generating revenue. With implementing of this invention, above mentioned limitations will be eliminated and will give a dynamic development in relations between all involved parts in the broadcasting industry.

### BRIEF SUMMARY OF THE INVENTION

The general purpose of the present invention, which will be described subsequently in detail later, is to provide method of conducting a reality show, heretofore as a prior art and novel features that which is not anticipated, rendered obvious, suggested, or even implied by any of the prior art, either alone or in any combination thereof.

Moreover, one embodiment of the present invention includes reality show broadcasted on different medias, including but not limited to TV, internet that is able to reach certain web site, radio any hand held device and any other media, or any combination a between medias, where the content of the reality show can switch between any media successfully and adequately without any limitation. In order for viewer to watch and interact with the reality show presentation, he/she need to have adequately and successfully connected all required hardware and software that are known in the prior art for successful broadcasting of the program.

Another embodiment of the present invention includes mandatory registration of the viewers who want to participate in the reality show, using any medias, where viewer can log in and create personal and secure file with database according the requirements of the show. All responses of the viewers may be collected, analyzed, selected, eliminated and/or kept by the central data receiving center, supported by a multy-media, multy-network server for qualification for the prizes based on predefined rules for the award of prizes to the participating viewers.

Another embodiment of the present invention includes unlimited numbers of episodes of the reality show, where every episode has its own rules. Every episode contents some requirements for the participant to fulfill in order to go to the next episode of the reality show. Some of the episodes may be shown live on the TV, some may be pre recorded and showed on the TV, and some may be presented on other medias. The purpose of these episodes/levels is to make selection between the viewers and to eliminate the viewers who are not providing satisfactory answer(s). The content of the episodes/levels of elimination are unrestricted and can be different, unlimited variety of forms of communications, such as, but not limited to, puzzles, surveys, crime stories, questions and answers, to ask the viewer to do something, to use some products and services, and the like.

Another embodiment of the present invention is to allow unlimited numbers of viewers to participate in the reality show. Every episodes/level of elimination may have different requirements for the participant and every level of elimination may have different rules. The rules of the episodes are presented to every participant where every participant is required to accept all rules and requirements regardless of its natures. Every rule is closely monitored by a number of judges for its correctness.

Another embodiment of the invention includes products and services from the advertising companies that are actively included in the reality show. In order to increase the advertising revenue, the reality show may include in its show an advertising products and services, where viewers will not only see the product and/or services that are advertised, but to implements them in their life, as a part of the reality show request for that certain level.

Another embodiment of the invention is to keep the viewer not to skip commercials between two parts of the reality show. In this embodiment, advertising is part of the reality show. In order to keep viewers to watch those commercials, clue that is needed for the next part of the episodes of elimination may be implemented in the commercials, so viewers must to watch the commercials if they want to continue playing the reality show.

Another embodiment of the invention is that advertising companies who are sponsoring the reality show may collect answers from the participant in the reality show, based on their lives and needs or other fields of interest that are valuable for the products and services that companies provides. In this way advertising companies will get clearer picture for the daily needs that are constantly changing based of the real life of the participant. Those advertising companies who are participating in the broadcasting program may receive personal information about the participant in the program, for money or for free.

In this respect, before explaining at least one embodiment of the invention in greater detail, it is to understand that invention is not limited in its application to the details and steps of construction and to arrangements of the components/steps set forth in the following description. The invention is capable of other embodiments and of being practiced and carried out in various ways. In addition, it is to be understood that the phraseology and terminology employed herein is for the purpose of description and should not be regarded as limiting.

As such, those skilled in the art will appreciate that the conceptions, upon which this disclosure is based, may readily be utilized as a basis for the designing of other structures, devices, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

### DEFINITIONS OF TERMS

The term “participant” herein denotes an individual person or a group of people who are part of the reality show according to the present invention.

The term “episode(s)” and “level(s)” herein denote a structural organizational hierarchy according to the present invention for purpose selectively to eliminate those participants who are not satisfy requirements for that episode/step of the reality show.

The term “business” herein denote a legal company that supports the reality show including, but not limited to financial support and try to reach more customers for its products and services.

The term “reality show” herein denotes broadcasted program where viewers of the program are invited to participate in it and to be part of the contest of the broadcasted program. The broadcasted program may be broadcasted on any media, including but not limited to TV, internet that is able to reach certain web site, any hand held device, radio, cable and satellite TV and/or any other combination between any medias known in the prior art.

The term “registration” herein denote process of creating a personal secure file with data already know in the prior art, such is in internet technology, where viewer participant must to fulfill a number of requirements and to have technological knowledge to use any device required by the rules and requirements.

### DETAILED DESCRIPTION OF THE PREFERRED EMBODIMENTS

One embodiment of the present invention includes reality show broadcasted on different medias, where the content of the reality show can switch between any media successfully and adequately without any limitation. In order for viewer to watch and interact with the reality show presentation, he/she need to have adequately and successfully connected all required hardware and software that are known in the prior art. That includes, but it is not limited to an adequately and functionally connected TV set, radio, cable and satellite TV, internet that is able to reach certain web site, and/or any hand held device that is able to receive and send an e-mails, to receive and send text messages and/or to interact with any other media successfully and adequately where the reality show is broadcasted, according requirements of the show.

The reality show invites people to participate in the reality show. All rules and requirements are presented to them as a part of the first episode. They have a limited time to participate in the show and they have to follow the rules and the requirements of the show. There is mandatory registration of any participants in the reality show. Registration of the participants may be through certain media, where user will create its own personal file with database that is protected with secure password and/or other security devices, and any participant will get unique personal name that will be used in the reality show according the requirements and rules of the show, as is already known in the prior art as a standard practice. All responses of the participants may be collected, analyzed, selected, eliminated and/or kept by the central data receiving center, supported by a multy-media, multy-network server for qualification of one or more prizes based on predefined rules for the award of prizes to the participating viewers.

The number of episodes of reality show is not limited in order to find the winner. The number of the episodes is based on the number of the participant in the reality show. Also every episode has its own rules and may have a same or different content from the previous episode. The number of participants in the show is unlimited at the beginning. The selection of the participants starts during or after the first episode of elimination is broadcasted.

Every episode doesn't need to be shown on the TV, but some of them may be shown at other medias, where major elimination process is conducted. If the reality show is shown once a week on TV, continuation between the episodes may be shown on other media. The reality show may be shown at different times on different medias, depends on the rules, requirements and the needs of the reality show. The content of the episodes of elimination are unrestricted and can be different, in unlimited variety of forms of communications, such as, but not limited to, puzzles, surveys, crime stories, questions and answers, to ask the viewer to do something, to use some products and services, and the like. The rules of the episodes are presented to every participant where every participant is required to accept all rules regardless of its natures. Every part of the reality show is closely monitored by a number of judges for its correctness.

The reality show may include in its show advertising products and services, where viewers participants will not only see the product and/or services that are advertised, but to implements them in their life, as a part of the reality show. For example, if the business that are advertising on the reality show sells photo papers, then as a part of the show, every participant need to make at least 10 photos, print them at the denoted business location with proof of printing from them, and send them to the reality show address. Then, the viewers visiting a certain web site will choose the best ones. The owners of the best picture will move to the next level of the show. Some of the best photos may be shown to the reality show that is broadcasted on TV and/or other adequate media.

Common practice by the viewers is to skip commercials between two parts of the reality show. In order to keep viewers to watch those commercials, clue that is needed for the next part of the episodes of elimination may be implemented in the commercials, so viewers must to watch the commercials if they want to continue playing the reality show. For example, in the first part is shown a riddle, then in the commercials may be shown the answer or help to solve the riddle, so when viewer continue to watch the next part, the riddle can be solved only if participants have the clue that was shown in the commercials. Also, their products and/or services may be part of the clue, or to be an option for solving the problem, or maybe is required from the viewer to use them as an answer of that level of elimination. Implementations of the clues in the commercials may be made from letter/letters, sign/signs, number/numbers, sound/sounds, color/colors, picture/pictures, and the like, and any combination between them.

Advertising companies who are sponsoring the reality show may collect answers from the participant in the show, based on their lives and needs or from other fields of interest that are valued for the product(s) and service(s) those companies. In this way advertising companies will get clearer picture for the daily needs of the participant. Those advertising companies who are participate in the broadcasting program may receive personal information about the participant in the program. Also, there is a contract between all parts that are participating in any way in the reality show and covers all legal aspects of the reality show.

Communications between the participants from one side, and reality show broadcasting program from other side are unlimited in all possible ways without any restrictions. All rules of the reality show are presented to the viewers in advance, in form that is clear to be understood. There are also chosen people from the reality show that controls and eliminate all mistakes that may happen during the show.

Depend of the answer of the participant, the participant is allowed to continue the show or to be eliminated. With every new episode, there is less and less participant and the winner is the participant who answers all questions correct. As a price he/she may receive the ultimate price. There is option that other participant who reaches level close to the final level, to receive some less valued prices. All these are regulated by the rules.

The reality shows episodes may be pre recorded and broadcasted on the TV and/or any other media, but process of eliminations may not need to be publicly presented. Also, there may be an additional question that are part of the reality show that are not shown on the TV, but every participant in each level will be contacted to answer those questions. Answering those questions may be timely limited in order to eliminate participant. Reality shows episodes may not be connected together by its content of the program and can be made of variety of different forms of creative questions and options that will help to eliminate participant in the reality show.

One embodiment of the invention is that every participant of the reality show will be ask for information regarding their style of live, about their needs and other questions that are provided as a part of the show query. Those information may be collected, selected, analyzed and/or kept securely, and may be offered to relevant companies for money or for free or the like. In this way companies who will receive that information will know the needs of the participants and they can develop its own products and services according their needs and can be offered to them.

The reality show is not geographically limited or limited by a language or in other way. Every participant in the show must be at lest 18 years old and to try to answer correct to every questions that are required in order to get the best price. There may be additional prices for the participants of the show.

The process of conducting a reality show, as an embodiment of the invention, is based on working unity of rules and requirements of the reality show, people that participate in the reality show, media that delivers the reality show and companies that sponsors the show, that works as one adequately and successful system. Viewers of the show are invited to participate in the reality show with passing adequately and successfully the process of registration. Then every participant who pass that stage must to accept the rules and requirements of the reality show and to have adequately and functionally connected device for successful communication with the media(s) that runs the reality show. Next step is that every viewer and/or participant of the show need to find solution for the task that is given to them. Based on requirements for that task and on the answer of the participant, the participant will go to the next level or not. If participant do not pass that step, his/her part in the reality show ends and need to wait for next available opportunity. If the participant passes this episode, which is a step of elimination, then he/she goes to the next episode, where participant must to accept same or different rules and requirements. This process of selecting participants through different episode and different media(s) is repeated until a single one participant left alone. He/she is the winner and will receive the main prize.

Having described the principles of my invention, it should be apparent that these steps of the invention are basic steps and that more steps may be added within the method. From the foregoing, it will be appreciated that, although specific embodiments of the invention have been described herein for the purposes of illustration, various modifications may be made without deviating from the spirit and scope of the invention. Accordingly, I claim all steps and modifications as many come within the scope and spirit of the following claims.

I claim:

1. Method of conducting a reality show comprising: reality show that is broadcasted through different media(s), unlimited numbers of participants of the show are allowed, unlimited numbers of episodes/levels/steps are conducted, business(es) that advertise its own product(s) and/or service(s) trough commercial breaks may be a part of the reality show.

2. A method as recited in claim 1, wherein said reality show further includes reality show where:
a) the show is created to invite an unlimited numbers of people to participate in the show, where through different episodes of the show elimination process of the participant viewers will be conducted in order to reach the winner of the show;
b) the show is broadcasted on different medias, including, but it is not limited to an adequately and functionally connected TV set, and/or internet that is able to reach certain web site, and/or radio, and/or any hand held device that is able to receive and send an e-mails, to receive and send text messages and/or to interact successfully and adequately with any other media where the reality show is broadcasted as known in prior art of broadcasting;
c) the people who want to participate in the show, may interact with the reality show presentation, and he/she need to have adequately and successfully connected all required hardware and software that are known in the prior art of the industry;
d) the number of episodes of reality show is not limited in order to find the winner and the number of the episodes is based on the number of the participant in the reality show, or on other requirements and rules of the reality show;
e) every episode has its own rules and requirements and may have a same or different content from the other episode;
f) every episode doesn't need to be shown on the TV, but some of them may be shown at other medias, where major elimination process is conducted, and where reality show may continue at other medias;
g) the reality show that is shown at media(s), may be shown every day of the week, or few times in the day, and the like, and depends on the numbers of people who wants to participate in the show and on the rules and requirements of the reality show;
h) the show is not geographically limited or limited by a language or in other way, where every participant in the show must be at least 18 years old;
i) the content of the episodes of elimination are unrestricted and can be different in every episodes in unlimited variety of forms of communications, such as, but not limited to, puzzles, surveys, crime stories, questions and answers, to ask the viewer to do something, to use some products and services in its life, and the like;
j) the rules of the episodes are presented to every participant where every participant is required to accept all rules regardless of its natures, where every rule and requirement is closely monitored by a number of judges for its correctness;
k) the show that is financially supported by business(es) who are advertising their product(s) and/or service(s) during the time of the reality show, where the reality show may include in its show those advertising product(s) and/or service(s), where viewers will not only see the product(s) and/or service(s) that are advertised, but to implements them in their life, as a part of the reality show;
l) communications between the participant of the reality show and reality show broadcasting program are unlimited in all possible ways without any restrictions;
m) all rules and requirements of the reality show are presented to the participant of the show in advance, in form that is clear to be understood and are accepted by the participant;
n) the reality shows episodes may be pre recorded and broadcasted on the TV and/or other media, but process of eliminations may not need to be publicly presented;
o) reality show episodes may not be connected together by the content of the program and can be made of variety of different forms of creative questions and options that will help to eliminate viewers who are participant in the reality show and select the winner.

3. A method as recited in claim 1, wherein said participants further includes participants who wants to participate in the show, and must to pass the registration process that may be done through a certain web site or other media, where viewer will create its own personal file with database that is protected with secure password and/or other security devices, and any participant will get unique personal name that will be used in the reality show according the requirements and rules of the show, as is known in prior art.

4. A method as recited in claim 1, wherein said participants further includes participants who accept that every responses of the viewers may be collected, analyzed, selected, eliminated and/or kept by the central data receiving center, supported by a multy-media, multy-network server for qualification of one or more prizes based on predefined rules for the award of prizes to the participating viewers.

5. A method as recited in claim 1, wherein said participants further includes participants that need to watch and listen commercials between the reality show parts, because clue that is needed for the next part of the episodes of elimination may be implemented in the commercials.

6. A method as recited in claim 1, wherein said product(s) and/or service(s) further includes product(s) and/or service(s) that may be part of the clue or of the solution, or to be an answer for solving the problem, or maybe is required from the participants to use them as an answer of that level of elimination.

7. A method as recited in claims 5 and 6, wherein said clue further includes clue(s) that may be made from letter/letters, sign/signs, number/numbers, sound/sounds, picture/pictures, product/products, service/services, color/colors, and the like, and any possible combination between them.

8. A method as recited in claim 1, wherein said business(es) further includes business(es) that may collect answers from the participant in the reality show, based on their lives, needs or other fields of interest that are valued for the products and services that companies provides.

9. A method as recited in claim 1, wherein said participants further includes participants who try to answer correct to every questions that are required.
